(19) United States
(12) Patent Application Publication
(10) Pub. No.: US 2010/0040533 A1
(43) Pub. Date: Feb. 18, 2010

(54) METHOD OF PRODUCING SUBSTOICHIOMETRIC OXIDES OF TITANIUM BY REDUCTION WITH HYDROGEN

(76) Inventors: Alexander Simpson, Chesire (GB); Philip Carter, Sydney (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/443,091

(22) PCT Filed: Sep. 26, 2006
(86) PCT No.: PCT/GB2006/003573

§ 371 Date: Jul. 30, 2009

(51) Int. Cl. C01G 23/04; B01J 19/00

(52) U.S. Cl. 423/608; 422/198; 422/105

(57) ABSTRACT

A method and apparatus are described for manufacturing Ebonex® articles such as rods and tiles from titanium oxide precursors. The precursors are held within the interior space of a kiln and heated in a reducing gas. The precursors are held so that the reducing gas is able to fully envelop them. In a preferred embodiment, the precursors are hung from a support within the kiln. The temperature of the kiln is also controlled to limit the initial heating of the kiln and to maintain the kiln within a predetermined range of operating temperatures.

The present invention relates to a method for the production of substoichiometric oxides of titanium known as Magnéli phases, and in particular those commercially produced and commonly referred to as Ebonex®.

Magnéli phases are members of the series of substoichiometric oxides of titanium with the general formula TiₙO₂ₙ₋₁ where the number n is between 4 and 10. Each phase is separate and identifiable, with a distinct structural identity. Magnéli phases exhibit desirable electrochemical properties. In particular, they possess a high electrical conductivity, comparable to that of graphite, while also, being ceramic materials, they are exceedingly resistant to corrosion.

The most highly conductive of the Magnéli phases is the lowest Magnéli phase Ti₄O₇, followed by Ti₅O₉. Materials made from the more conductive Magnéli phases with the amounts of Ti₄O₇ and Ti₅O₉ maximised in order to obtain high conductivity combined with high corrosion resistance have been manufactured commercially under the name ‘Ebonex®’. This has been produced in many different forms, including plates, rods, tubes and powder.

There has been great interest in using these Magnéli phases and Ebonex® in particular: as a ceramic electrode material in applications requiring the use of aggressive electrolytes; as a replacement for precious metal coated anodes; as electrodes for batteries and fuel cells; for electrowinning; for use in cathodic protection; electrochemical soil remediation; for the oxidation of organic wastes; and for water purification.

Magnéli phases are produced by high temperature reduction of titanium oxides in a hydrogen atmosphere. The conductivity of the resulting material depends upon the particular Magnéli phase(s) produced.

Previously, the applicant has manufactured Ebonex® articles in the following manner:
1) Articles of TiO₂ starting material were placed horizontally in ceramic saggers layered with powdered activated carbon.
2) The saggers were then placed in a Bell furnace (kiln), where the temperature was raised to and held at 1180° C. for 8 hours, during which time the TiO₂ material was left to undergo a reduction reaction in a hydrogen atmosphere. The rate of hydrogen addition was not usually controlled.
3) After 8 hours, the furnace was allowed to cool naturally until the temperature was at or below 200° C., at which point the furnace was opened and the saggers removed from the furnace.
4) Each article was then visually inspected for cracks.
5) The presence of the desired Magnéli phases in each article was then determined using a semi-empirical testing procedure.

The applicant has found that the above process is inconsistent in its production of Ebonex® material and often requires repeated “cooking” of the article which results in high losses due to breakages. There are also issues with operational failure of the Ebonex® as a consequence of not forming the correct balance of the desired Magnéli phases. Ideally, the Ebonex® material formed would consist entirely of Ti₄O₇, the most conductive of the Magnéli phases. In practice, however, some Ti₃O₅ is invariably formed also. A readily achievable balance of phases is for no more than 4% Ti₃O₅ with at least 30% Ti₄O₇ and/or at least 50% Ti₄O₇ and Ti₅O₉, the remainder being made up of the other higher oxides.

The present invention therefore aims to provide an alternative process for manufacturing Magnéli phases, and Ebonex® in particular, that overcomes, or at least alleviates, one or more of the problems discussed above.

According to one aspect, the present invention provides a method of manufacturing substoichiometric oxides of titanium (such as Ebonex®), the method comprising: holding a titanium oxide precursor into the interior space of a kiln; introducing a reducing gas into the interior space; and heating the interior space in order to heat the precursor and the reducing gas, to cause the reduction of the titanium oxide precursor to form the substoichiometric oxides of titanium. The method is such that the precursor is held in the interior space so that said reducing gas can substantially fully envelop the precursor.

The method preferably uses convection as the main method of heating the precursor. When the heating is achieved using heating elements provided on the inside of the kiln, a thermal shield is preferably used to minimise or at least reduce heating caused by radiant heat produced by the heating elements. The inventors have found that reducing radiant heating of the precursor reduces cracking and over reduction. A ceramic fibre blanket is preferably used as the thermal shield between the precursor and the heating elements.

In order to facilitate the free circulation of the reducing gas around the precursor, a gap is preferably provided between the thermal insulator and a support used to hold the precursor.

In the embodiment to be described below, a support is provided by means of four box-like frames, each being able to hold 96 precursor rods within the interior space of the kiln, thus allowing a total of 384 rods to be produced during each heating and reduction cycle.

The heating of the interior space is preferably controlled so that during an initial heating stage the interior space is heated at a rate not exceeding about 200° C. per hour, until the interior space reaches a predetermined operating temperature above 1170° C. In one embodiment the temperature of the interior space is maintained within a temperature range between 1170° C. and 1190° C. for a period of time of between five and eight hours.

During the heating step, the introduction of the reducing gas is controlled so that the reducing gas is introduced at a predetermined rate during said heating step. In one embodiment the reducing gas is introduced at a rate of between two and five cubic meters per hour.

The precursor can be held by or suspended from the support. Suspension of the precursor is preferred as this is easy to achieve for monolithic precursors having various different shapes (such as rods, tubes, plates, tiles etc).

The inventors have found, contrary to recent suggestions made by other Ebonex® manufacturers, that a desiccant (such as powdered activated carbon) provided in the interior space of the kiln during the heating and reduction process helps to absorb moisture that is generated and thereby helps to reduce cracks in the resulting precursor.

If desired, the resulting precursor can be pulverised to form powdered substoichiometric oxides of titanium.

These and other aspects of the present invention will become apparent from the following exemplary embodiments that are described with reference to the accompanying Figures in which:

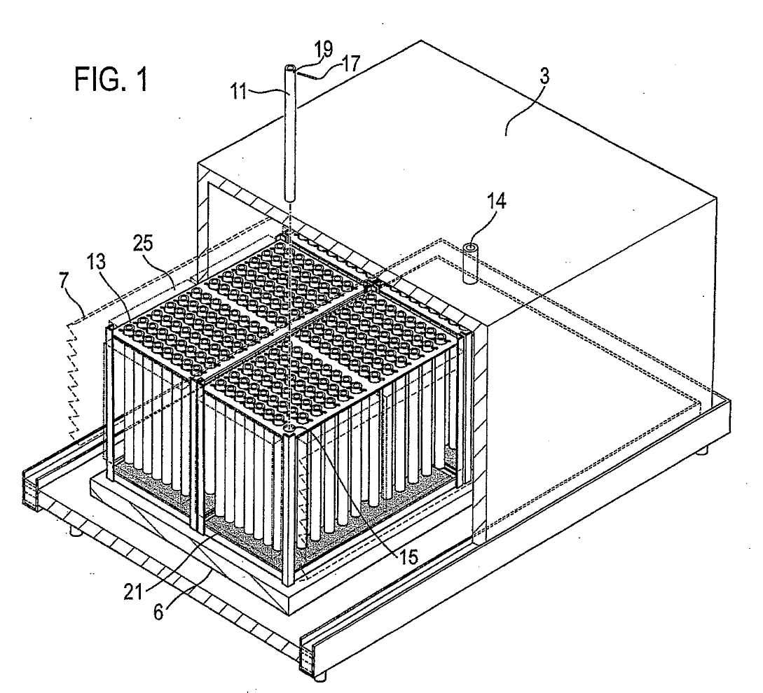

FIG. 1 is a three dimensional part cut away view of a kiln used in a novel process for the manufacture of Ebonex® rods;

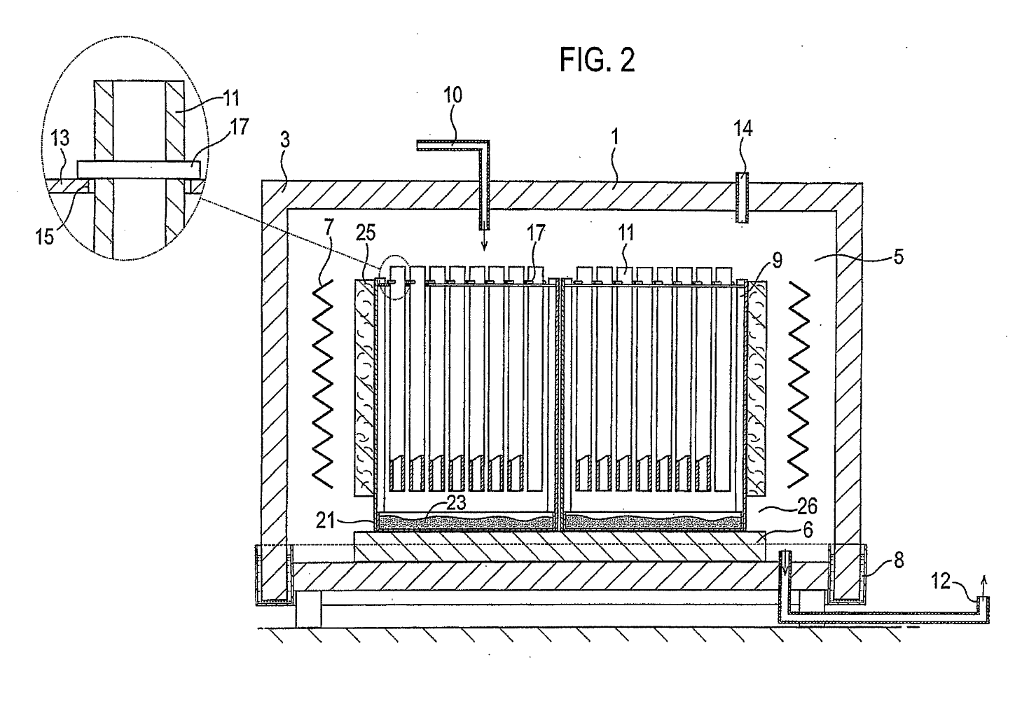

FIG. 2 is a cross-sectional view of the kiln shown in FIG. 1;

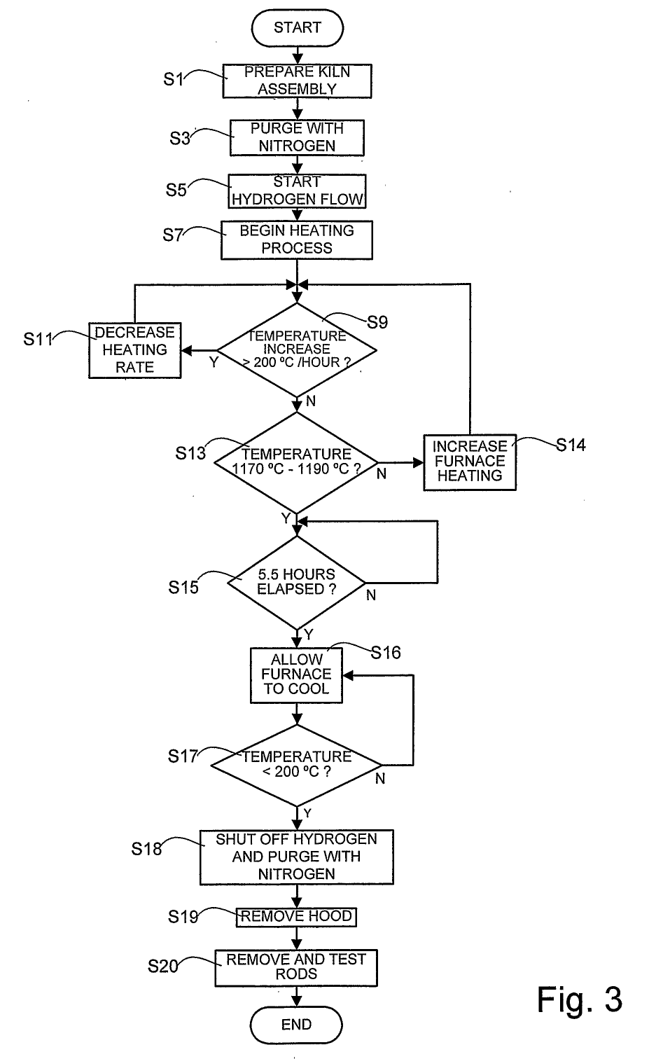

FIG. 3 is a flow chart showing the steps taken to make the Ebonex® rods using the kiln shown in FIG. 1; and

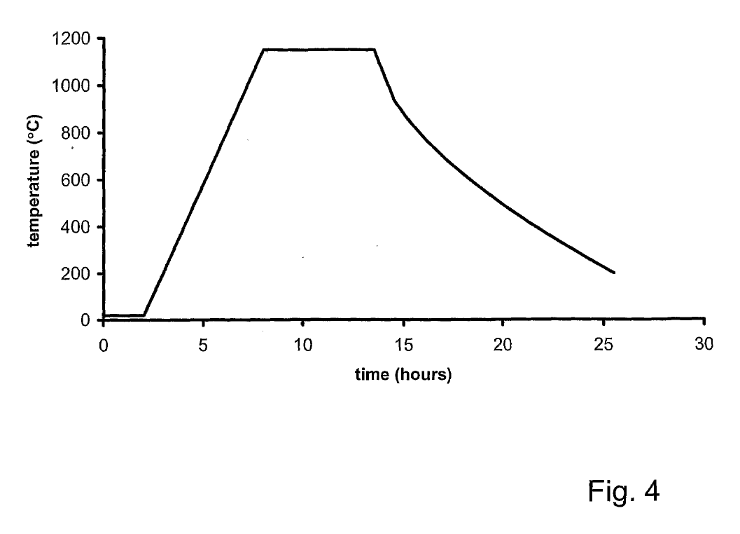

FIG. 4 is a plot showing the way in which the temperature of the kiln is varied during the manufacturing process.

### Kiln

FIG. 1 is a part cut-away view of a kiln assembly 1 used to make Ebonex® rods and FIG. 2 is a cross-sectional view of the kiln assembly 1. As shown in these Figures, the kiln assembly 1 includes a heat resistant hood 3 which defines an interior space 5 above a brick base 6. Heating elements 7 are provided on the inside and adjacent the hood 3 for heating the interior space 5. The interior space 5 is sealed by positioning the hood 3 in an oil filled trough 8 that surrounds the brick base 6. The top of the kiln 1 has a gas inlet 10 and a vent 14. A gas outlet 12 is provided through the base 6.

In this embodiment, four box-like frames 9 are provided for suspending precursor rods (tubes) 11, made of titanium oxide, within the interior space 5 of the kiln 1. In order to withstand the temperatures involved in the manufacturing process (to be described below), the frames 9 are made from a high-temperature alloy, such as Inconel® nickel-chromium-iron 601 alloy.

In this embodiment, each frame 9 includes a top plate 13 having 96 circular holes 15 arranged in a regular array (ie arranged in rows and columns), through which the precursor rods 11 are suspended. The inventors found that these holes 15 should be sized to have a diameter that is greater than 1.2 times the diameter of the precursor rods 11 in order to provide room for the expansion of the rods 11 during the heating and reduction process. The inventors found that when smaller holes are used more of the rods 11 cracked during the heating and reduction process. In this embodiment the holes 15 are sized in the above manner so that they can be used with rods 11 having a diameter of up to 18 mm.

As shown in FIGS. 1 and 2, each precursor rod 11 is suspended under its own weight from the top plate 13 by a pin 17, which is inserted through a hole 19 at the top of the rod 11 (which passes through the rod 11 in a direction perpendicular to the rod's longitudinal axis). The pins 17 are preferably aligned with each other in order to reduce the likelihood of the rods 11 swinging into each other during the heating and reduction process. In this embodiment, the rods 11 are approximately 200 mm long and each frame 9 is dimensioned so that each rod 11 hangs freely within the interior space 5 above a tray 21 filled with powdered activated carbon 23. In this way, during the heating and reduction process, the hydrogen gas used for the reduction can substantially fully envelop the rods 11. The carbon 23 is provided (in powdered, solid or granular form) for removing excess moisture from the interior space 5 during the heating and reduction process. The inventors have found that without the carbon 23, there is a greater risk of over reduction which affects the formation of the desired Magnéli phases. Over time, the absorption of water vapour results in the carbon 23 being consumed as it is converted into carbon dioxide. The activated carbon 23 must, therefore, be replenished or replaced from time to time. In the preferred embodiment, the carbon is replaced every three production cycles.

The four frames 9 are positioned side by side in two rows and two columns and the outer sides of the frames 9 (ie the sides closest to the heating elements 7) are clad in a protective shielding 25, such as a ceramic fibre or a low thermal mass insulation blanket, to minimise (if not avoid) the exposure of the rods 11 to direct radiant heat from the heating elements 7. In the preferred embodiment, the protective shielding 25 is standard grade Fiberfrax® Durablanket® of 96 kg/m³ density and 25 mm thick, which is made of blown alumino-silicate ceramic fibre and classified to operate at temperatures of 1250° C. The shielding 25 is attached to the frames 9 and hangs down below the bottom of the rods 11. A gap 26 of approximately 25 mm is provided between the bottom of the shielding 25 and the tray 21 to allow for good circulation of the hydrogen gas during the heating and reduction process.

An oxygen meter (not shown) and two thermocouples (not shown) are located at different positions in the interior space 5 and are provided for generating measurements to aid in the control of the manufacturing process.

A description has been given above of the kiln assembly 1 used in this embodiment. A description will now be given of the way in which the kiln assembly 1 is used to manufacture Ebonex® rods 11 in this embodiment.

### Production Process

FIG. 3 is a flowchart illustrating the production process used in this embodiment. As shown, in step S1, the kiln assembly 1 is prepared, by suspending the rods 11 of titanium oxide from the frames 9; adding activated carbon 23; sealing the internal space 5 by lowering the hood 3 into the oil-filled trough 8; opening the inlet 10 and the outlet 12 and closing the top vent 14. Once the hood 3 is in place, nitrogen is pumped into the inlet 10, in step S3, at a rate of approximately three cubic meters per hour for a minimum of fifty minutes, in order to purge the interior space 5 of oxygen. An oxygen meter (not shown) is used to confirm when the oxygen has been removed to the 2% level. At this point, the nitrogen flow is stopped and, in step S5, hydrogen is pumped into the inlet 10 at a rate of approximately four cubic meters per hour. Hydrogen will continue to be pumped into the inlet 10 until the end of the heating and reduction process and throughout the subsequent cooling. After about 50 minutes have elapsed from the start of the hydrogen introduction, the oxygen meter is again consulted to ensure the remaining oxygen level is below 2% before a further oxygen test is undertaken. This test includes filling a small container with gas from the outlet 12 and, at a safe distance, applying a lit taper to the container. If the gas held within the container ignites with a loud pop, then this indicates that the oxygen level in the interior space 5 remains too high to proceed with the reduction process. Whereas, if the gas held within the container burns slowly, with a lazy flame, then it is safe to proceed with the reduction process. The hydrogen escaping at the outlet 12 is then lit and allowed to burn off as the reduction process proceeds.

The heating process is then started, in step S7, by switching on the heating elements 7. The initial heating is controlled in steps S9 and S11 by a controller so that the interior space 5 is heated at a rate not exceeding 200° C./hour. Once the internal temperature reaches the operating temperature of between 1170° C. and 1190° C. (controlled in steps S13 and S14), the controller maintains the operating temperature in step S15 for approximately 5.5 hours. At the end of this time the heating elements 7 are switched off and the kiln 1 is allowed to cool naturally in step S16 until the internal temperature is below 200° C. (which typically takes about fourteen hours). FIG. 4 shows the typical temperature variation inside the kiln 1 during the production process and illustrating the initial heating stage, the reduction stage and the cooling stage.

The inventors have found that there is no detriment to the rods 11 if they remain in the kiln 1 for longer periods (after the heating elements 7 have been switched off), but they found that removing them earlier can result in crazing which affects their quality. Once the internal temperature is below 200° C. (as determined in step S17), the hydrogen flow is halted, the outlet 12 is closed and the top vent 14 is opened. Nitrogen gas is then pumped in via the inlet 10 into the internal space 5 to purge the hydrogen gas out via the top vent 14 where it is lit and allowed to burn off. Once the flame has extinguished, indicating that there is no more hydrogen within the interior space 5, the hood 3 is removed in step S19 and the rods 11 are removed and tested in step S20.

In this embodiment in step S20, each rod 11 is tested using the following semi-empirical tests:
1. By a colour observation (by a human or machine). Magnéli phases have a characteristic blue-black colouration, and this is required to be uniform over the length of the rod 11; any discolouration is taken as evidence of unwanted oxides having been formed.
2. A two-point probe electrical conductivity test, in which a current of 100 mA is passed through the rod 11 and the voltage drop measured between two probes on the rod 11 that are a placed 100 mm apart from each other is compared with a threshold and if it is greater then the rod fails.

Failure of either or both tests results in the rod being rejected.

In addition to the above tests, X-ray diffraction measurements may be obtained on some or all of the rods 11 to confirm the Magnéli phases that are present.

The inventors have found that holding the rods 11 freely within the interior space 5 results in better quality Ebonex® rods 11 being produced in a more consistent manner with fewer breakages compared to the prior art method described above. The inventors also found that rods 11 processed in the above manner have a significantly greater conductivity compared to the rods 11 obtained using the prior art process discussed above. In particular, the inventors have found that typically rods 11 obtained using the above process and when tested using the above test, exhibit lower average voltage drops, indicating higher conductivities, than rods obtained using the prior art process. Table 1 below, illustrates the typical spread of measured voltage drops in millivolts achieved in one production run across ten arbitrary positions across the top plate 13 using the above described production method.

TABLE 1

| ROD POSITION | FRAME 1 | FRAME 2 | FRAME 3 | FRAME 4 |
|---|---|---|---|---|
| 1 | 29.5 | 31.5 | 33 | 35.9 |
| 2 | 30.7 | 33.6 | 36.1 | 40.8 |
| 3 | 33 | 30.2 | 39.8 | 33.2 |
| 4 | 36.9 | 38.6 | 34.5 | 43.3 |
| 5 | 35.2 | 40.3 | 35.9 | 41.5 |
| 6 | 37.7 | 39.5 | 41.7 | 41.1 |
| 7 | 36.7 | 36.6 | 38.5 | 37.5 |
| 8 | 33.9 | 33.8 | 32.3 | 31.3 |
| 9 | 37 | 37.8 | 34.5 | 34.3 |
| 10 | 36.9 | 33.3 | 33.5 | 30.3 |
| AVERAGE | 34.75 | 35.52 | 35.98 | 36.92 |

As shown, the average voltage drop is about 35 millivolts. In contrast, similar tests performed on rods manufactured using the prior art technique, results in typical measured voltage drops in the range of 65 to 70 millivolts, with some as high as 120 to 130 millivolts. In the latter case, those rods would then be reprocessed by running them through the heating and reduction process again.

### MODIFICATIONS AND ALTERNATIVES

In the above embodiment, the precursor rods were hung from a frame within the kiln. In an alternative embodiment the rods may be stood directly on the floor of the kiln 1, but the inventors found that this resulted in a greater percentage of the rods being broken during the heating and reduction process. In a further alternative, the precursors may be supported by one or more supports so that they can be fully enveloped by the reducing gas.

In the above embodiment, precursor tubular rods were heated in the kiln to produce Ebonex® tubular rods. As those skilled in the art will appreciate, other shaped precursors can be used. For example, the precursors can be plates, tiles, sheets etc. Additionally, the resulting Ebonex® material may be pulverised to produce Ebonex® powder.

In the above embodiment the rods were fully enveloped in the reducing gas during the reduction process. As those skilled in the art will appreciate it would be possible to cover a portion of each rod (for example, one end of each rod) and still produce the rods using the present invention. The term “fully enveloped” used in the description and the claims should therefore be construed broadly to also cover the situation where the rods are substantially fully enveloped.

In the above embodiment, a controller was used to control the heating and reduction process. As those skilled in the art will appreciate, this controller can be a human controller or an automated one.

1. A method of manufacturing substoichiometric oxides of titanium, the method comprising:
suspending a titanium oxide precursor into the interior space of a kiln;
introducing a reducing gas into the interior space; and
heating the interior space to heat the precursor and the reducing gas to cause the reduction of the titanium oxide precursor to form the substoichiometric oxides of titanium;
wherein said suspending suspends said precursor in said interior space so that said reducing gas can substantially fully envelop said precursor
wherein said heating uses a plurality of heating elements located within the interior space of said kiln; and
further comprising shielding said precursor from radiant heat produced by said heating elements.

2-3. (canceled)

4. A method according to claim 1, wherein said shielding uses a thermal insulator to shield said precursor.

5. A method according to claim 4, comprising holding said precursor by a support and providing said thermal insulator between the support and the heating elements.

6. A method according to claim 5, comprising providing said thermal insulator between said support and said heating elements to leave a gap between a lower edge of the thermal insulator and a base of the kiln, to thereby allow free circulation of said reducing gas around said precursor.

7. A method according to claim 1, wherein said suspending suspends a plurality of said precursors within said interior space of the kiln so that said plurality of precursors are reduced during said heating.

8. A method according to claim 1, wherein said heating includes an initial heating stage in which the interior space is heated at a rate not exceeding a predetermined threshold until the interior space is above a predetermined operating temperature.

9. A method according to claim 8, wherein said initial heating stage heats the interior space at a rate not exceeding 200° C. per hour.

10. A method according to claim 8, wherein said initial heating stage ends when said interior space reaches an operating temperature above 1170° C.

11. A method according to claim 8, wherein said heating includes a second heating stage in which the temperature of the interior space is held within a predetermined operating temperature range for a predetermined period of time.

12. A method according to claim 11, wherein said second heating stage maintains the temperature of the interior space within a temperature range between 1170° C. and 1190° C. for said predetermined period of time.

13. A method according to claim 11, wherein said second heating stage maintains said interior space within said operating temperature range for a period of time of between five and eight hours.

14. A method according to claim 1, comprising stopping said heating and allowing said interior space to cool down to a predetermined temperature.

15. A method according to claim 14, comprising removing the precursor from the kiln after the interior space has cooled down below 200° C.

16. A method according to claim 1, wherein said introducing introduces said reducing gas at a predetermined rate during said heating.

17. A method according to claim 16, wherein said introducing se introduces said reducing gas at a rate of between two and five cubic meters per hour.

18. (canceled)

19. A method according to claim 1, comprising testing said precursor after said heating step to determine if the desired substoichiometric titanium oxides have been formed and rejecting the precursor if it is determined that the desired substoichiometric titanium oxides have not been formed.

20. A method according to claim 19, wherein said testing includes visually inspecting the precursor to observe the colouration thereof.

21. A method according to claim 19, wherein said testing includes determining a measure of the conductivity of the precursor after the heating and comparing the determined measure with a predefined threshold value.

22. A method according to claim 1, comprising providing a desiccant within the interior space of the kiln to absorb moisture generated during the heating.

23. A method according to claim 22, wherein said desiccant comprises powdered activated carbon.

24. A method according to claim 1, wherein said precursor is rod shaped or a plate shaped.

25. A method according to claim 24, further comprising pulverising the precursor after said heating to form powdered substoichiometric oxides of titanium.

26. An apparatus for manufacturing substoichiometric oxides of titanium, the apparatus comprising:
a kiln having a base and a hood defining an interior space of the kiln;
a support operable to suspend a titanium oxide precursor in the interior space of the kiln;
an inlet for introducing a reducing gas into the interior space of the kiln; and
heating elements operable to heat the interior space of the kiln to cause the reduction of the titanium oxide precursor to form the substoichiometric oxides of titanium;
shielding material for shielding said precursor from radiant heat produced by said heating elements;
wherein said support is operable to suspend said precursor in said interior space so that said reducing gas can substantially fully envelop said precursor.

27. An apparatus according to claim 26, wherein said heating elements are located within the interior space of said kiln.

28. (canceled)

29. An apparatus according to claim 26, wherein said shielding material comprises a thermal insulator to shield said precursor.

30. An apparatus according to claim 29, wherein said thermal insulator is provided between the support and the heating elements.

31. An apparatus according to claim 30, wherein said thermal insulator is positioned between said support and said heating elements so that a gap is provided between a lower edge of the thermal insulator and a base of the kiln, to thereby facilitate free circulation of said reducing gas around said precursor.

32. An apparatus according to claim 26, wherein said support is operable to suspend a plurality of said precursors within said interior space of the kiln so that said plurality of precursors can be reduced at the same time.

33. An apparatus according to claim 26, comprising a controller operable to control said heating elements so that, during an initial heating stage, the interior space is heated at a rate not exceeding a predetermined threshold until the interior space is above a predetermined operating temperature.

34. An apparatus according to claim 33, wherein said controller is operable to control said heating elements so that, during said initial heating stage, the interior space is heated at a rate not exceeding 200° C. per hour.

35. An apparatus according to claim 33, wherein said controller is operable to control said heating elements so that said initial heating stage ends when said interior space reaches an operating temperature above 1170° C.

36. An apparatus according to claim 33, wherein said controller is operable to control said heating elements so that, during a second heating stage, the temperature of the interior space is held within a predetermined operating temperature range for a predetermined period of time.

37. An apparatus according to claim 36, wherein said controller is operable to control said heating elements so that said second heating stage maintains the temperature of the interior space within a temperature range between 1170° C. and 1190° C. for said predetermined period of time.

38. An apparatus according to claim 36, wherein said controller is operable to control said heating elements so that said second heating stage maintains said interior space within said operating temperature range for a period of time of between five and eight hours.

39. An apparatus according to claim 33, wherein said controller is operable to switch off said heating elements to allow said interior space to cool down to a predetermined temperature.

40. An apparatus according to claim 39, comprising means for removing the precursor from the kiln after the interior space has cooled down below 200° C.

41. An apparatus according to claim 26, comprising a controller operable to control the rate at which said reducing gas is introduced into said interior space.

42. An apparatus according to claim 41, wherein said controller is operable to control said inlet so that said reducing gas is introduced at a rate of between two and five cubic meters per hour.

43. (canceled)

44. An apparatus according to claim 26, further comprising means for testing said precursor after said heating step to determine if the desired substoichiometric titanium oxides have been formed and means for rejecting the precursor if it is determined that the desired substoichiometric titanium oxides have not been formed.

45. An apparatus according to claim 44, wherein said testing means includes means for visually inspecting the precursor to observe the colouration thereof.

46. An apparatus according to claim 44, wherein said testing means includes means for determining a measure of the conductivity of the precursor after the heating step and means for comparing the determined measure with a predefined threshold value.

47. An apparatus according to claim 26, further comprising a tray for holding a desiccant within the interior space of the kiln to absorb moisture generated during the reduction process.

48. An apparatus according to claim 47, wherein said desiccant comprises powdered activated carbon.

49. An apparatus according to claim 26, wherein said precursor is rod shaped or plate shaped.

50. An apparatus according to claim 49, further comprising means for pulverising the precursor after said heating step to form powdered substoichiometric oxides of titanium.

51. A method of manufacturing substoichiometric oxides of titanium, the method comprising:
placing a titanium oxide precursor into the interior space of a kiln;
introducing a reducing gas into the interior space; and
heating the interior space to heat the precursor and the reducing gas to cause the reduction of the titanium oxide precursor to form the substoichiometric oxides of titanium;
characterised in that said placing places said precursor in said interior space so that the majority of the heating of the precursor performed in said heating is achieved by convection.

52-53. (canceled)

54. An article comprising substoichiometric oxides of titanium, the article being manufactured using the method of claim 1.
